(19) United States
(12) Patent Application Publication
(10) Pub. No.: US 2022/0300954 A1
(43) Pub. Date: Sep. 22, 2022

(54) DECENTRALIZED TAGGING USING TOKENIZED STRINGS

(71) Applicant: Hashtag Protocol Inc., San Anselmo, CA (US)

(72) Inventor: Michael PALER, San Anselmo, CA (US)

(73) Assignee: Hashtag Protocol Inc., San Anselmo, CA (US)

(21) Appl. No.: 17/698,862

(22) Filed: Mar. 18, 2022

Related U.S. Application Data
(60) Provisional application No. 63/162,763, filed on Mar. 18, 2021.

(51) Int. Cl. G06Q 20/36

(52) U.S. Cl. CPC G06Q 20/3678

(57) ABSTRACT

A decentralized system for creating, managing, and using cryptographic, non-fungible tokens (NFTs) for tagging digital assets is provided. The digital assets are tagged with tokens (e.g., Tag Tokens) and APIs for surfacing this data for use in publisher networks, platforms, dApps and applications.

### TECHNICAL FIELD

The disclosed technology relates to a decentralized tagging service that enables third-party services (e.g., dApps, platforms, applications, smart contracts, etc.) and/or their customers to tag any addressable online artifact (non-fungible tokens (NFTs), uniform resource locations (URL), or transaction records) and record it to the blockchain.

### BACKGROUND

Web services and their customers use tagging to increase discoverability and engagement of online content. This widespread use gives tagging data and the tags themselves immense social, functional, and monetary value. Various problems exist with known tagging implementations (e.g., social media tags). Due to the technical infrastructure by which tags are currently created and managed, the data is siloed and managed in an overly centralized manner. These silos and the over-centralization leads to several technical and other problems. One of the technical problems is that, due to a certain level of anonymity that exists due to technical features inherent with the internet and social media sites, tags, as well as the content they are applied to, are often manipulated, promoted, or censored for political or economic reasons. Additionally, analyzing and interpreting global tag data requires significant, complex technical resources, and tag data is centralized among a few large enterprises. The current technical approaches to creating and managing tags suffers from these and other shortcomings. As a result of these technical drawbacks other adverse consequences arise, e.g., the social, informational, and financial equity of both tagging data and the tags themselves is siloed and guarded by a limited number of large entities.

With standard decentralized networks, there is not an effective technological solution to enable the tagging of content across various blockchain and other DLT platforms. As a result, there are various technical drawbacks in part due to the decentralized technological approach.

No suitable technical solution is known to exist to overcome these and other technical problems with prior tag creation and management solutions.

### BRIEF SUMMARY OF EMBODIMENTS

The disclosed technology relates to a decentralized tagging service that enables third-party services (dApps, platforms, applications, smart contracts) and/or their customers to tag any addressable online artifact (NFTs, URLs, transaction record) and record it to the blockchain. The service employs a novel approach where the tags themselves may correspond with non-fungible cryptographic tokens that can be re-used for subsequent tagging by any participant of the system. Once recorded, the service indexes the tagging data and exposes it via public APIs.

One aspect of the invention relates to a system and method that leverages a decentralized (e.g., blockchain or other DLT) system for creating cryptographic non-fungible tokens (NFTs) that represent a unique tag string, storing and managing the tokens via a blockchain, linking them to any addressable online artifact (e.g. URL, image, transaction, Tweet, etc.) and providing APIs for surfacing online content tagged with a particular tag string via different networks, platforms, dApps, and applications. For simplicity, these tokens will be referred to herein as Tag Tokens.

Tag Tokens are digital representations of tags and/or text strings stored as non-fungible tokens (NFTs) on a blockchain. For purposes of example only, reference will be made to the Ethereum® blockchain (e.g., a decentralized, open-source blockchain featuring smart contract functionality). Other blockchains or decentralized networks may be used. The NFTs may use the Ethereum® ERC-721 specification for the Tag Tokens. Tag Tokens can be used to promote and increase engagement with content by making it more easily discoverable both within and between decentralized applications. These tokens can be minted (or generated,) and used to tag digital assets in accordance with a technical protocol, e.g., the Tag Protocol, as described herein.

Unlike centrally controlled platforms (e.g., social media platforms) where the platform owner typically owns, manages and/or controls the tag strings for that platform, one aspect of the invention enables individual users of a platform (or other application) to create a tag string, mint an NFT Tag Token for that tag string and have ownership and control of that Tag Token. The ownership of that Tag Token may be managed by storing a crypto wallet ID of the user with the NFT and storing that data on a blockchain. A set of platforms may all agree to use the Tag Protocol. According to one aspect of the invention, the protocol will only allow a single token for a specific tag string across all of the platforms that use the Tag Protocol.

While the invention enables individual ownership of tag tokens, the token remains openly accessible (i.e. is usable for tagging online content) by all other applications implementing the protocol. Because the token is stored on a decentralized public blockchain, no entity, even the owner, may censor, edit, or destroy the Tag Token.

In addition to creating NFTs that both contain and represent tag strings, the Tag Protocol provides a facility for linking the Tag Tokens to any addressable online content referred to by the Tag Protocol as a “target” or artifact, effectively “tagging” that artifact with the tag string. This is facilitated when application developers provide their own interface built on top of the set of smart contracts, each of which is described below. The user interface may enable a user to create a hashtag for a tag string if one does not already exist, tag content with a previously created hashtag and perform various search functions. For example, a user can search by hashtag to identify digital assets and/or other content tagged with that tag.

At least one of the tagging contracts (e.g., core tagging contract or other group of predefined, computer-implemented rules of the Tag Protocol) may have a “pluggable” architecture that enables third party application developers to extend a core tagging contract to support additional target or asset (used interchangeably) types. Using this, any application developer can extend the service with a target type contract specific to the target type of their interest. This means virtually any addressable online artifact on the internet (e.g., URL, jpeg, Tweet, public blockchain transaction, etc.) may be tagged (be a target type) in the Tag Protocol.

Target type subcontracts may be transmitted from one or more user devices to an application programming interface (API) associated with the Tag Protocol. Once submitted, the Tag Protocol may review the subcontracts and approve them if they comply with one or more predetermined rules stored with the Tag Protocol.

In some examples, developers can extend the Tag Protocol core tagging contract with a target type subcontract interface, each of which is described below.

The tagging contracts may enable the implementing platform or a user of their platform to create a new Tag Token tag for a tag string if one does not already exist, tag content with the newly created Tag Token or previously created Tag Tokens, and perform various search functions. For example, a user can search by tag string to identify digital assets and/or other content tagged with the corresponding Tag Token.

The smart contracts may be a set of computer instructions, stored and executed on a decentralized network that track transactions, interactions, and operations associated with smart contracts. The smart contract may correspond with a self-executing contract with the terms of the agreement between a buyer and a seller (e.g., associated with the Tag Token) being directly written into lines of software code. The software code and the agreements contained in the smart contract may exist across the distributed, decentralized blockchain network.

The smart contracts may further support a many-to-many token-to-target relationship. For example, the user may tag a target with a single Tag Token (which, by association, tags them with the unique tag string stored in the token). Or, one Tag Token can be used to tag many targets or one target can be tagged with many Tag Tokens.

Multiple different publisher platforms may use the minting and tagging features with the smart contract engine. The smart contract engine may utilize a shared token data store and shared graphing engine. A single Tag Token may be consistently referenced across multiple different platforms in a decentralized manner, rather than relying on a first platform to maintain and store a tag string that might be different in a second platform.

A tagging smart contract may be designed to allow for a target to be tagged with any number of Tag Tokens. Conversely, any single Tag Token may be used to tag many different targets.

Tagging data may be stored in a decentralized, immutable and easily accessible global database (e.g., IPFS, The Graph), or other databases. This is in contrast to many social networks that utilize free tagging to capture and store tag strings solely within their own systems. The Tag Token (and tagging data) may be stored in a global, decentralized database and added to this database by creator users and systems interacting with the protocol.

When the tag tokens are minted or targets/assets are tagged, the tagging data associated with the tag token is stored or logged to the blockchain. At the same time, the smart contract emits an event that contains the transaction data. Any platform using any variety of technology/protocol may “listen” for these events and then log that data in their own way. The “listening” technology may itself be decentralized. In our case, the Protocol listens for transaction events using the decentralized technology run by The Graph or other decentralized graphing database. In contrast to accessing blockchain data which is slow, inefficient and laborious, accessing data via a subgraph database is relatively faster and easier.

Tag Tokens may be created by executing the mint( ) or TagTarget( ) methods in an ERC-721 smart contract (described below). As one option, only safelisted publisher addresses may mint tag tokens. In some embodiments, safelisted publishers are enabled by giving their wallet address the Publisher Role (e.g., using the Open Zeppelin access control smart contract otherwise) and storing that on the blockchain. Only users with an admin role (ie. the Protocol) can assign a publisher address to that role. Minting and tagging events may be captured by the Tag Protocol Subgraph hosted on the graphing engine (described below).

Once a target is tagged, the system may surface and display tagging data in a variety of ways. The Tag Protocol Subgraph may be used to rapidly query Protocol transaction data and present it in a desired way. The user interface may include various search tools or other search options for a user to search for tags and/or tagged content.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a platform for providing decentralized tokenization of tag strings, in accordance with the embodiments disclosed herein.

FIG. 2 depicts a functional block diagram that illustrates various aspects of the disclosure.

FIG. 3 illustrates an example of tagging data in traditional systems.

FIG. 4 illustrates an example of tagging data in accordance with the embodiments disclosed herein.

FIG. 5 illustrates an example of providing decentralized tokenization of tag strings, in accordance with the embodiments disclosed herein.

FIG. 6 illustrates an example of a tagging smart contract design, in accordance with the embodiments disclosed herein.

FIG. 7 illustrates an example of a graphing engine, in accordance with the embodiments disclosed herein.

FIG. 8 illustrates an interface to create, manage and use tag data, in accordance with the embodiments disclosed herein.

FIGS. 9-13 illustrate sample interfaces for implementing decentralized tokenization of tag strings, creation of tags and tagging content in accordance with the embodiments disclosed herein.

FIG. 14 depicts an example of a search interface to search for tagged content based on existing tags.

FIG. 15 is an example process for providing decentralized tokenization of tag strings, in accordance with at least one embodiment disclosed herein.

FIG. 16 is an example of a computing system that may be used in implementing various features of embodiments of the disclosed technology.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

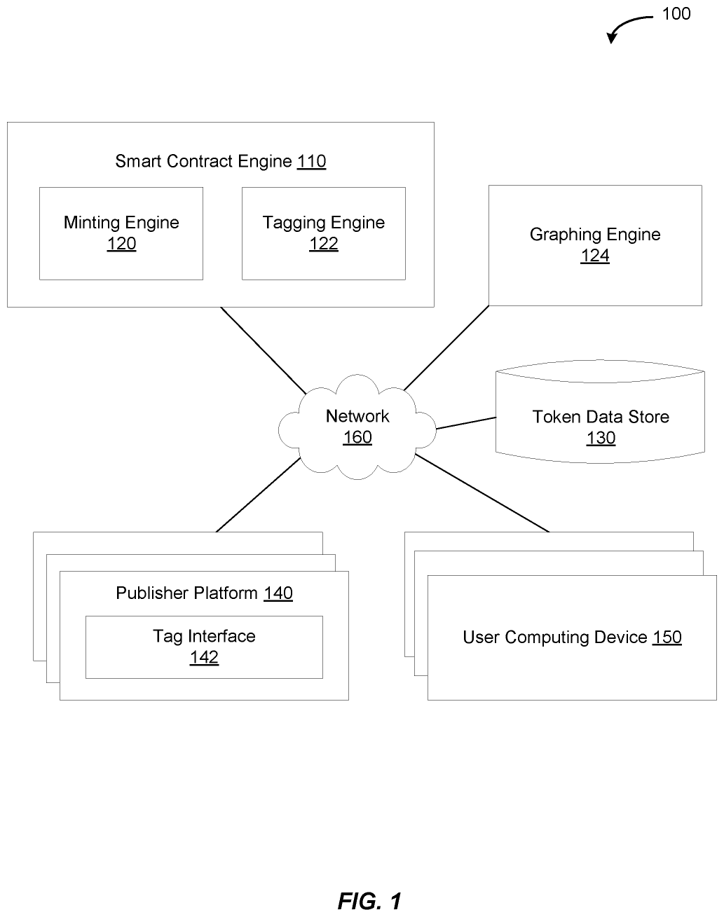

FIG. 1 illustrates a platform for providing decentralized tokenization of tag strings, in accordance with the embodiments disclosed herein. In illustration 100, smart contract engine 110 may comprise one or more components for executing computer-readable instructions that perform various steps described herein. The components may comprise, for example, minting component 120 and tagging component 122. Smart contract engine 110 may electronically communicate with graphing engine 124, which may provide a query language for APIs to access databases to query the blockchain data. The data may be stored in token data store 130 (e.g., the InterPlanetary File System (IPFS), including a protocol and peer-to-peer network for storing and sharing data in the distributed file system). Smart contract engine 110 may also communicate with publisher platforms 140 and user computing device 150 via network 160.

Minting engine 120 is configured to create a new Tag Token. The creation of a new Tag Token may be created alone or in conjunction with digital asset tagging implemented by tagging engine 122. Once created and/or stored in token data store 130, the new Tag Token may be used on publisher platform 140 to tag digital assets by any user on any publisher platform 140.

Minting engine 120 is also configured to validate that the string contained and referenced by a tag adheres to various characteristics. The characteristics may include that the string stored in the Tag Token contains only Unicode/UTF-8 encoded characters and has no spaces. The characteristics may also limit the components of the string (e.g., minimum 3 characters with at least 1 alphabetic character, maximum 32 characters, etc.).

There may be no predetermined upper limit to the number of Tag Tokens that can be minted and stored in token data store 130. In some examples, the primary requirement is that the text string is unique and valid.

The tag string may be a unique name among the entire universe of Tag Tokens. If not, smart contract engine 110 may reject the process during minting. Strings may not be case sensitive. All Tag Tokens may be reduced to lowercase. Other string dynamics (length, special characters, etc.) may be specified.

Minting engine 120 may create a Tag Token in accordance with a token standard, including ERC-721 or other computer-implemented rules or protocol. Smart contract engine 110 may limit the creation of the tokens to unique tokens and define a minimum interface a smart contract must implement to allow unique tokens to be managed, owned, and traded. The minimum interface may include, for example, event handling for transfers, function call approvals, or returning a balance or owner. The minimum interface code is provided for illustrative purposes only.

event Transfer(address indexed from, address indexed to, uint256 indexed tokenId);

event Approval(address indexed owner, address indexed approved, uint256 indexed tokenId);

event ApprovalForAll(address indexed owner, address indexed operator, bool approved);

function balanceOf(address owner) public view returns (uint256 balance);

function ownerOf(uint256 tokenId) public view returns (address owner);

function approve(address to, uint256 tokenId) public;

function getApproved(uint256 tokenId) public view returns (address operator);

function setApprovalForAll(address operator, bool approved) public;

function isApprovedForAll(address owner, address operator) public view returns (bool);

function transferFrom(address from, address to, uint256 tokenId) public;

function safeTransferFrom(address from, address to, uint256 tokenId) public;

function safeTransferFrom(address from, address to, uint256 tokenId, bytes memory data) public

Tag Tokens metadata may be stored in token data store 130. One example of token data store 130 may include the InterPlanetary File System (IPFS), which comprises a protocol and peer-to-peer network for storing and sharing data in the distributed file system. Token data store 130 can use content-addressing to uniquely identify each file in a global namespace connecting all computing devices. The contents of token data store 130 may comprise tagged data, including cryptographic, non-fungible tokens (NFTs) for tagging digital assets with those tokens and APIs for surfacing this data for use in publisher networks, platforms, dApps and applications. In some examples, each Tag Token contains and represents a unique tag string. There may only be one instance of each Tag Token to create a non-fungible characteristic of the Tag Token.

The Tag Token may comprise one or more parameters after the minting process. The parameters may comprise, for example, a unique identifier (ID) of the tag, a tag string, creator user ID (e.g., wallet ID and/or other identifier information), publisher user, price, and uniform resource identifier (URI).

A wallet address of the creator user (e.g., the user that created the Tag Token) or process creating the Tag Token may be stored as well. After successful Tag Token creation, this address of the creator user (e.g., the wallet address) may be stored permanently inside the Tag Token.

Upon successful creation, Tag Token ownership may be delegated to the Tag Protocol. For example, the Tag Protocol may offer ownership of the Tag Token at public auction in exchange for funds or other virtual or physical items.

A wallet address of the publisher user (e.g., the user that provides an interface or application (or dApp) to create the Tag Token) may be stored as well. The interface could be a widget provided by smart contract engine 110, or an implementation of the publisher user. The creator user and publisher user can be the same wallet address.

The price may correspond with a value corresponding with minting a new Tag Token. The cost may be set by smart contract engine 110 for the creator user to mint a new Tag Token. The funds received may be distributed between the publisher platform 140 and smart contract engine 110 (e.g., at fixed proportions, set by smart contract engine 110, etc.).

The uniform resource identifier (URI) may correspond with an asset of the Tag Token. For example, when a Tag Token is minted (e.g., a smart contract is successfully implemented), smart contract engine 110 may dynamically create an image representing the Tag Token and upload it to the URI location.

Minting engine 120 may implement one or more mint( ) functions. A mint( ) function is provided for illustrative purposes only and may be used to mint or generate a new tag token (e.g., ETSTAG). In this illustrative example, the tag string may pass validation and the publisher may be safelisted prior to minting. In some examples, the parameter “_tag” may correspond with the tag string to mint and/or may include a hashtag (#) character at beginning of string. In some examples, the parameter “_publisher” may correspond with an address to be logged as the publisher. In some examples, the parameter “_creator” may correspond with an address to be logged as the creator. In some examples, the parameter “_tokenId” may correspond with an identifier for newly minted tag tokens.

```
  function mint( string calldata _tag, address payable _publisher, address
_creator ) external payable returns (uint256 _tokenId) {
  require(accessControls.isPublisher(_publisher), “Mint: The publisher
must be safelisted”);
  // Perform basic tag string validation.
  string memory machineName = _assertTagIsValid(_tag);
  // generate the new ETSTAG token id.
  tokenPointer = tokenPointer.add(1);
  uint256 tokenId = tokenPointer;
  // mint the token, transferring it to the platform.
  _safeMint(platform, tokenId);
  // Store ETSTAG data in state.
  tokenIdToTag[tokenId] = Tag({
  displayVersion: _tag,
  machineName: machineName,
  originalPublisher: _publisher,
  creator: _creator
  });
  // Store a reverse lookup.
  tagToTokenId[machineName] = tokenId;
  emit MintTag(tokenId, _tag, _publisher, _creator);
  return tokenId;
  }
```

Minting engine 120 is configured to generate Tag Data APIs.

Tagging engine 122 is configured to link a token to a digital asset, which may effectively tag that content with the Tag Token. Different processes may be used for immutable content (e.g., tied to specific content and unchangeable after a point of time) versus mutable content (e.g., tied to specific content at one point of time and can reference different content at a separate point in time). Tagging of other NFTs may be an example of immutable content tagging. Tagging of web-based content is an example of mutable content tagging.

With mutable tagging, it may be desirable to address the ephemeral nature of content on the centralized internet. Websites and web pages may be removed. Digital assets like PDFs and images may be removed. Another consideration is digital asset classification. The Tag Token may link implied content and may be contained in the tagging metadata stored to the blockchain.

Tagging engine 122 is configured to implement one or more TagTarget( ) functions. A TagTarget( ) function is provided for illustrative purposes only. In this illustrative example, the process described herein may tag a target with a tag string. In some examples, the parameter “_tagString” may correspond with a string target that is being tagged with. In some examples, the parameter “_targetURI” may correspond with a uniform resource identifier or URL of the target being tagged. In some examples, the parameter “_publisher” may correspond with an address of publisher enabling the tagging record. In some examples, the parameter “_tagger” may correspond with an address of the tagger being credited performing the tagging record. In some examples, the parameter “_ensure” may correspond with a Boolean flag that can be set to true to ensure the target at time of tagging.

```
function tagTarget(
    string calldata _tagString,
    string calldata _targetURI,
    address payable _publisher,
    address _tagger,
    bool _ensure
  ) public override payable nonReentrant {
    require(accessControls.isTargetTypeAndNotPaused(msg.sender),
“Only target type”);
    require(accessControls.isPublisher(_publisher), “Tag: The publisher
must be safelisted”);
    require(msg.value >= taggingFee, “Tag: You must send the fee”);
    // require(targetType[_targetType], “Target type: Type not
    permitted”);
        // Get targetId if the target exists, otherwise, create a new one.
        uint256 targetId = getTargetId(
          accessControls.targetTypeContractName(msg.sender),
          _targetURI
        );
        // Get tagId if the tag exists, otherwise, mint a new one.
        uint256 tagId = getTagId(_tagString, _publisher, _tagger);
        if (_ensure) {
          // TODO: Only ensure if not previously ensured or user wants
to re-ensure.
          ensure.requestEnsureTarget(targetId);
        }
        // TODO: may determine that only tags target if ensured.
        _tagTarget(tagId, targetId, _publisher, _tagger);
      }
```

Graphing engine 124 is configured to implement one or more query( ) functions. A query( ) function is provided for illustrative purposes only.

```
query {
  tags(first: 5, orderBy: timestamp, orderDirection: desc) {
    id
    tagId
    tagName
    nftContract
    nftContractName
    nftImage
    nftName
    nftId
    tagger
    timestamp
    publisher
  }
}
```

Graphing engine 124 is configured to capture the minting and tagging transactions by a Tag Protocol Subgraph. This may permit querying Tag Protocol data in extremely efficient and targeted ways.

Once content is tagged, the system may surface and display tagging data in a variety of ways. Minting and tagging events are captured by the Tag Protocol Subgraph hosted on graphing engine 124. The Tag Subgraph may be used to rapidly query transaction data and present it in a desired way.

In some embodiments, graphing engine 124 may correspond with a decentralized query protocol for indexing and querying data from blockchains and networks like Ethereum and IPFS (e.g., related to token data store 130). The Graph Network decentralizes the API and query layer of the internet application stack making it possible to efficiently query blockchain data without relying on a centralized service provider.

Graphing engine 124 enables users to build and publish open APIs called subgraphs, to make data easily accessible. Graphing engine 124 indexes data based on subgraph descriptions, known as the subgraph manifest. The subgraph description defines the smart contracts of interest for a subgraph, the events in those contracts to pay attention to, and how to map event data to data that subgraph.

By way of example, the Tag Token platform may leverage graphing engine 124 as follows. The Tag Token platform adds data to a blockchain (e.g., Ethereum) through a transaction on one of the Tag Token smart contracts. The Tag Token smart contract emits one or more events while processing the transaction. One or more graph Nodes continually scans the relevant blockchain for new blocks and the data a subgraph. The Graph Node finds events for the subgraph in these blocks and runs a mapping handler. The mapping may be a WASM module that creates or updates the data entities that Graph Node stores in response to the events. The decentralized application queries the Graph Node for data indexed from the blockchain, using the node's GraphQL endpoint. The Graph Node in turn translates the GraphQL queries into queries for its underlying data store in order to fetch this data, making use of the store's indexing capabilities. The decentralized application displays this data in a UI for end-users, which they can use to create new transactions.

Graphing engine 124 is also configured to return data from a graph query. An illustrative example of data (e.g., JSON object) being returned from a graph query is provided for illustrative purposes only.

```
{
  “data”: {
    “tags”: [
      {
        “tagId”: “5”,
        “tagName”: “bob”,
        “id”:
“0x749819150d62630594d3b600699fdabb87c47c0997ace7e8da00c91f54e4ad59”,
        “nftContract”: “0x2df6816286c583a7ef8637cd4b7cc1cc62f”,
        “nftContractName”: “KnownOriginDigitalAsset”,
        “nftId”: “50401”,
        “nftImage”:
“https://ipfs.infura.io/ipfs/QmUhQxQPi1XbzRzJ8T9PDCWZugsoG29ytEkq7bpWbuWcU
C”,
        “nftName”: “Bonsai code”,
        “publisher”: “0xd677aed0965ac9b54e709f01a99ceca205aebc”,
        “tagger”: “0xd677aed0965ac9b54e709f01a99ceca205aebc”,
        “timestamp”: “1599750144”
      },
      {
        “tagId”: “11”,
        “tagName”: “jenkins”,
        “id”:
“0x4720dcac73ae6adcc0280206413f5665d362c9e908385b69fa223ac0bcd8e9f0”,
        “nftContract”: “0x2df6816286c583a7ef8637cd4b7cc1cc62f”,
        “nftContractName”: “KnownOriginDigitalAsset”,
        “nftId”: “41101”,
        “nftImage”:
“https://ipfs.infura.io/ipfs/QmSas9z2iudgDFfZc5fJzpzMYEbv5hy6LyroYQCGLtT9GW”,
        “nftName”: “Dreaming Big Color Dreams”,
        “publisher”: “0xd677aed0965ac9b54e709f01a99ceca205aebc”,
        “tagger”: “0xd677aed0965ac9b54e709f01a99ceca205aebc”,
        “timestamp”: “1599749949”
      },
      {
        “tagId”: “10”,
        “tagName”: “mountains”,
        “id”:
“0x7a13da22d607297d7ef1cc05bce61a44ce7710591af0e5247129f83ae0af1d”,
        “nftContract”: “0x2df6816286c583a7ef8637cd4b7cc1cc62f”,
        “nftContractName”: “KnownOriginDigitalAsset”,
        “nftId”: “51201”,
        “nftImage”:
“https://ipfs.infura.io/ipfs/QmY4XQ2qvrRwEZWr918BCjbW35Q7WJ7rsYZsDB1f8fhk7K”,
        “nftName”: “webp”,
        “publisher”: “0xd677aed0965ac9b54e709f01a99ceca205aebc”,
        “tagger”: “0x07bd3b64f9f51fe1d5c79f81dfc0460fff305b0e”,
        “timestamp”: “1596246628”
      },
      {
        “tagId”: “9”,
        “tagName”: “blue”,
        “id”:
“0x7e1c2541271d253f00beeaf2f8c73b67fdf3b4d21e4a8cb8a188ef3f6aae1d6c”,
        “nftContract”: “0x2df6816286c583a7ef8637cd4b7cc1cc62f”,
        “nftContractName”: “KnownOriginDigitalAsset”,
        “nftId”: “41101”,
        “nftImage”:
“https://ipfs.infura.io/ipfs/QmSas9z2iudgDFfZc5fJzpzMYEbv5hy6LyroYQCGLtT9GW”,
        “nftName”: “Dreaming Big Color Dreams”,
        “publisher”: “0xd677aed0965ac9b54e709f01a99ceca205aebc”,
        “tagger”: “0xd677aed0965ac9b54e709f01a99ceca205aebc”,
        “timestamp”: “1596124648”
      },
      {
        “tagId”: “8”,
        “tagName”: “noeyes”,
        “id”:
“0x81eda4e8a6d7bf435e62fc32ad7607e20c09bebd1ab33926687c44d831d586”,
        “nftContract”: “0x2df6816286c583a7ef8637cd4b7cc1cc62f”,
        “nftContractName”: “KnownOriginDigitalAsset”,
        “nftId”: “50401”,
        “nftImage”:
“https://ipfs.infura.io/ipfs/QmUhQxQPi1XbzRzJ8T9PDCWZugsoG29ytEkq7bpWbuWcU
C”,
        “nftName”: “Bonsai code”,
        “publisher”: “0xd677aed0965ac9b54e709f01a99ceca205aebc”,
        “tagger”: “0xd677aed0965ac9b54e709f01a99ceca205aebc”,
        “timestamp”: “1596124528”
      }
    ]
  }
}
```

Publisher platform 140 may comprise an application, network, or platform implementing the Tag Protocol to provide their customers and/or application content tagging stored to a decentralized, globally readable database. Publishers may include websites, dApps, applications, or other entities that utilize the Tag Protocol to provide their system with a rich, robust content tagging framework.

New Tag Tokens may be created via publisher platform 140. When a user tags content on a publisher site that implements the protocol (or other computer-implemented rules) with a Tag Token that does not exist, a new Tag Token can be created (e.g., by minting, tagging, and storing in token data store 130). Additionally, a publisher may provide a widget for creating new tags, as illustrated with tag interface 142.

Publisher platform 140 can utilize a tagging widget provided by smart contract engine 110, develop a custom widget, or other implementation of the protocol. The Tag Protocol supports “tagging” of other online content via the linking of Tag Tokens to online content. This is achieved via an Ethereum smart contract implemented by Publishers within their dApps and applications.

User computing device 150 interacts with the created Tag Token. Two or more types of users may operate each user computing device 150, including a creator and a tagger. A creator is a user that creates (“mints”) a new Tag Token. A creator interacts with tagging/minting widgets on publisher platform 140. A Tagger is a user that interacts with a tagging widget on Publisher platform to tag digital content.

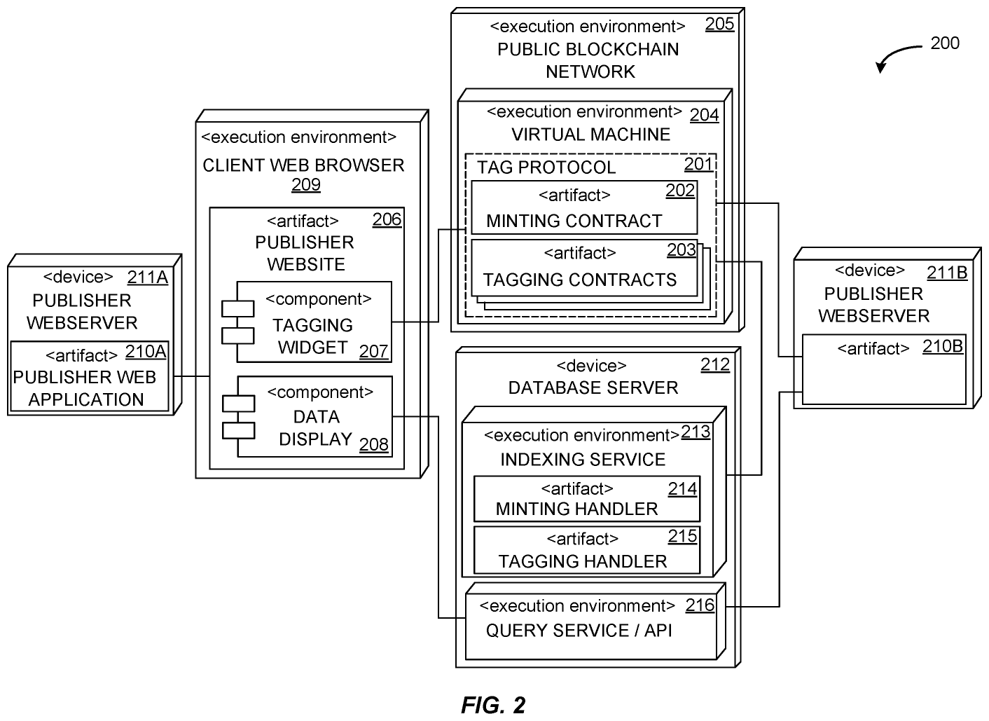

FIG. 2 illustrates an example of a decentralized platform for tokenization of tag strings, in accordance with the embodiments disclosed herein. In illustration 200, tag protocol 201 is provided as a decentralized computer system for centralizing creation of tag tokens that are usable across a plurality of publisher platforms. Tag protocol 201 may be implemented in communication with one or more public blockchain networks that tag protocol 201 runs with, as well as the centralized clients and web servers that tag protocol 201 interacts with.

In some examples, tag protocol 201 is implemented with minting contract 202 and/or tagging contract 203. Minting contract 202 and/or tagging contract 203 can be deployed onto, but not limited to, a smart contract capable virtual machine platform 204 running on a public blockchain network 205. The deployment may be included in an execution environment.

In some examples, publisher website 206 may interact with tag protocol 201 and also with publisher webserver 211. A plurality of publisher webservers 211 are provided, illustrated as first publisher webserver 211A and second publisher webserver 211B, each comprising one or more artifacts 210, illustrated as first artifact 210A and second artifact 210B. Artifacts 210 may communicate with a client web browser 209 that implements publisher website 206 and publisher website 206 may implement its own components that correspond with minting contract 202 and/or tagging contract 203, including tagging widget 207 and/or data display widget 208.

Tagging widget 207 and/or data display widget 208 may provide components delivered through first artifact 210A (illustrated as a publisher web application) via first web server 211A to an end user via a web browser 209. In an alternative example, second publisher webserver 211B may interact with tag protocol 201 directly from their application or other artifact 210B with no user interface.

The data captured by tag protocol 201 may be indexed by a third party indexing service 213 running on a centralized or decentralized database server 212. Indexing service 213 may implement event handlers listening for minting events 214 or tagging events 215 (e.g., corresponding with electronic messages to detect each event). The data may be provided through a public facing API 216. The user device may query or otherwise access the tagging data captured by tag protocol 201.

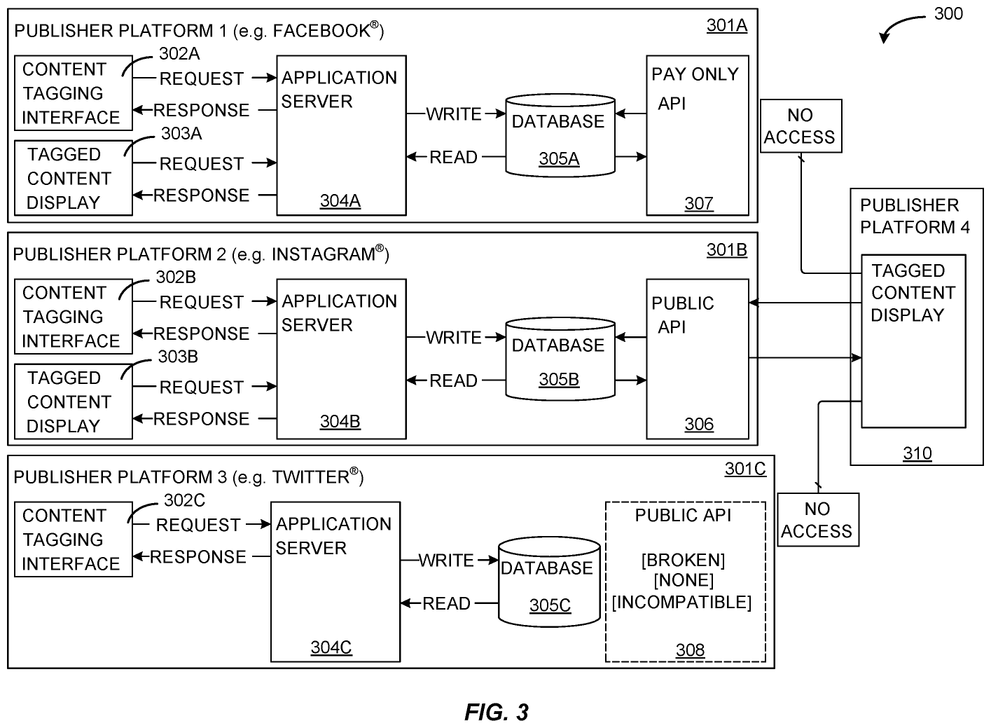

FIG. 3 illustrates an example of tagging data in traditional systems. In illustration 300, a plurality of publisher platforms 301 are illustrated as first publisher platform 301A, second publisher platform 301B, and third publisher platform 301C. Each of these decentralized platforms may independently tag data in isolated instances. The tagged data may be stored in separate databases 305, which are illustrated as first database 305A corresponding with first publisher platform 301A, second database 305B corresponding with second publisher platform 301B, and third database 305C corresponding with third publisher platform 301C. The tagged data may be isolated and not sharable between these separate databases 305.

Access to the tagged data may be limited to, for example, third-party consumer applications associated with each publisher platform 301. For example, each publisher platform 301 may implement content tagging interface 302 (illustrated as first content tagging interface 302A corresponding with first publisher platform 301A, second content tagging interface 302B corresponding with second publisher platform 301B, and third content tagging interface 302C corresponding with third publisher platform 301C) and/or tagged content display interface 303 (illustrated as first tagged content display interface 303A corresponding with first publisher platform 301A, second tagged content display interface 303B corresponding with second publisher platform 301B, and third tagged content display interface 303C corresponding with third publisher platform 301C).

In some examples, content tagging interface 302 or tagged content display interface 303 may access respective databases 305 to read and write data to them. These interfaces may also access isolated application servers 304, which are illustrated as first application server 304A corresponding with first publisher platform 301A, second application server 304B corresponding with second publisher platform 301B, and third application server 304C corresponding with third publisher platform 301C. Each application server 304 may be implemented within the individual publisher platforms.

In some examples, each publisher 301, at their discretion, may choose to expose proprietary tagging data to third-party publisher applications 310 via an open or public API 306, a pay-gated API 307 (e.g., limiting access to an API after initiating and completing a payment transaction), or the third-party publisher applications 310 may choose not to expose any public API 308.

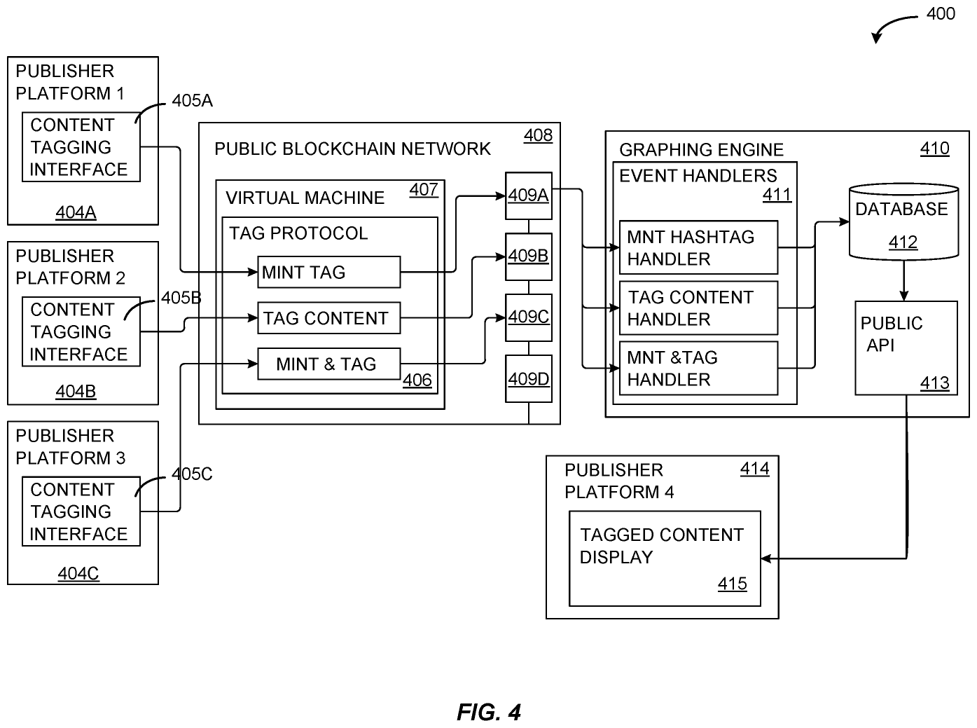

FIG. 4 illustrates an example of tagging data in accordance with the embodiments disclosed herein. Tag protocol 406 illustrated in FIG. 4 may be similar to tag protocol 201 illustrated in FIG. 2.

A plurality of publisher platforms 405 may interact with tag protocol 406. For example, tag protocol 406 may implement machine readable instructions for electronic processing of tagging data, saving the tagged data to a common, decentralized blockchain network 408, and exposing the tagged data (by tag protocol 406) via public APIs to third-party data consumer applications.

In illustration 400, a plurality of publisher platforms 404 are provided, which are illustrated as first publisher platform 404A, second publisher platform 404B, and third publisher platform 404C. Each publisher platform may comprise a content tagging interface 405 (illustrated as first content tagging interface 405A, second content tagging interface 405B, and third content tagging interface 405C), which are similar to the content tagging interface 302 illustrated in FIG. 3. Other publisher platforms may also be provided, including fourth publisher platform 414 that comprises a tagged content display interface 415, which is similar to the content tagging interface 303 illustrated in FIG. 3.

The plurality of publisher platforms 404 may implement their own content tagging interfaces 405 that interact directly with tag protocol 406 components. For example, the content tagging interfaces 405 may communicate with the minting contract and/or tagging contract that may be installed in an smart contract, which can be compatible with virtual machine 407 running on a public blockchain network 408.

When one or more of the plurality of publisher platforms 405 submit tagging data to tag protocol 406, valid transactions may be written to the blockchain 408 in data blocks 409. An external graphing engine 410 can listen for the tagging events (e.g., creation of the data blocks 409 using event handlers 411. Once a tagging event is detected, external graphing engine 410 can write the tagging data to a high-speed, searchable database 412 that may be suitable for a public-facing API 413 or other interface, which may be similar to open or public API 306 illustrated in FIG. 3.

In some examples, the public-facing API 413 may then be accessed by one or more publisher platforms, including fourth publisher platform 414 that comprises a tagged content display interface 415. For example, fourth publisher platform 414 may receive, detect, and/or display the tagged data via tagged content display interface 415.

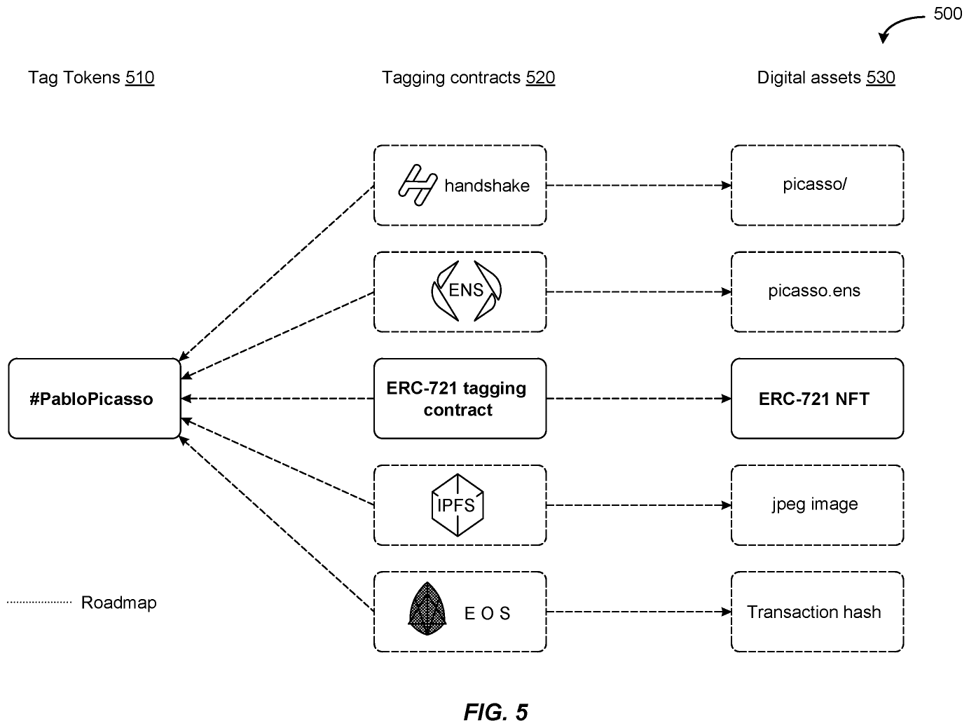

FIG. 5 illustrates an example of the relationship of entities, in accordance with the embodiments disclosed herein. In illustration 500, tokenized tag strings may correspond with a tag token 510 and digital asset targets 530. The tagging contracts 520 may correlate the tag tokens 510 with the digital asset targets 530.

Tag tokens 510 may be created by executing the mint( ) or TagTarget( ) methods in an ERC-721 smart contract on a participating publisher application, as illustrated with publisher platform 140 in FIG. 1. As one option, only safelisted publisher addresses may mint Tag Tokens.

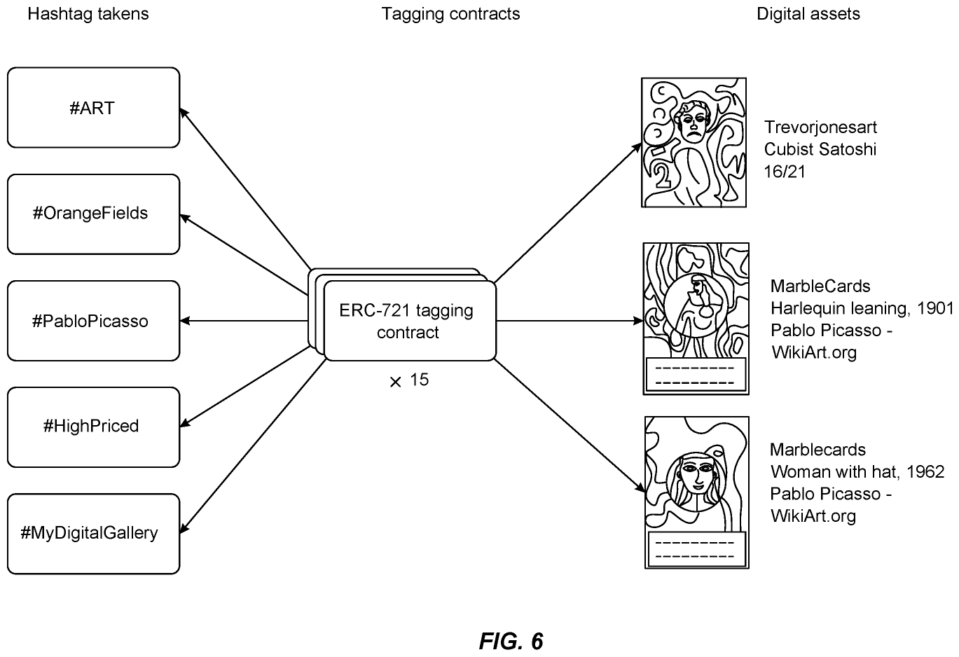

The user may tag any addressable online artifact or “target” with Tag Tokens 510. The tag protocol can provide a set of smart contracts 520 for linking a Tag Token 510 to any online digital asset 530, effectively “tagging” that content with a tag string. Tagging contract design allows for a digital asset to be tagged with any number of Tag Tokens and conversely, any single Tag Token to tag many digital assets, as illustrated with FIG. 6.

In the illustrative example shown in FIG. 5, the tagging contract utility may be extended by smart contracts for linking a Tag Token to any online digital asset or target, effectively “tagging” that content with a tag string. Tagging data may be saved on the blockchain.

In the illustrative example, the tagging is performed on ERC-721 NFTs as a target. The system may include computer-implemented rules to validate that the target being tagged is an ERC-721 token. The computer-implemented rules may utilize a many-to-many TAG-to-ERC-721 NFT relationship. In other words, a single ERC-721 NFT target can be tagged with any number of Tag Tokens and conversely, a single Tag Token may tag any number of ERC-721 NFT targets. The tagger user may tag any ERC-721 NFT with any Tag Token. The tagger user may also use an existing Tag Token or create a new Tag Token and tag at the same time via TagTarget( ) method.

When costs are associated with the process, the tagger user may pay the fees. For example, the tagger user may pay the Ethereum transaction fee plus a Protocol fee. The Protocol fee, paid by the tagger user, may be divided and distributed to an accrual account for participants in the following manner, for example, 70% Owner, 20% Publisher, and 10% Protocol. If the Tag Token is not owned (e.g., for newly minted Tag Tokens yet to be released at auction), the Owner portion may accrue to the Creator and redirect to the new Owner if and when the Tag Token is purchased. Accrued token sale and tagging funds may be distributed to the participant wallet at any time, with corresponding transaction fees.

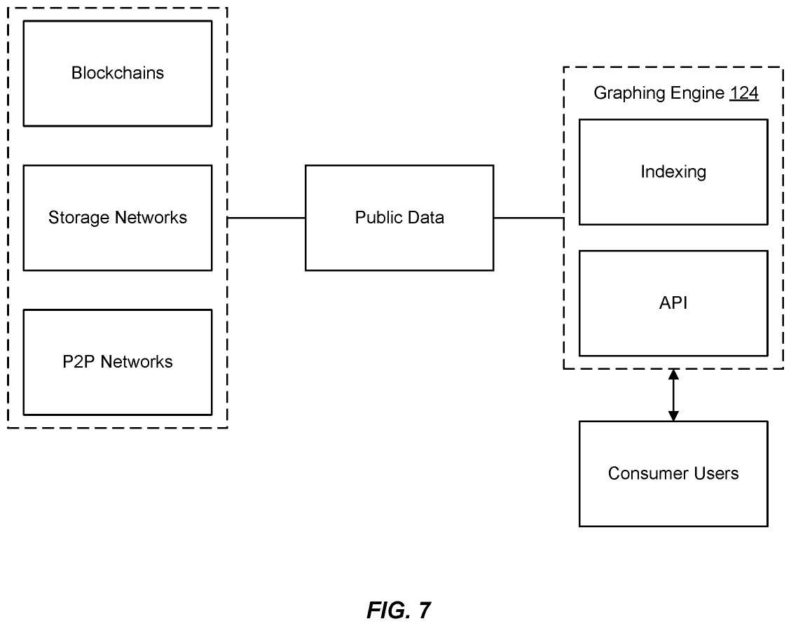

Once the data is tagged, graphing engine 124 may receive the data and process it for a consumer user, as illustrated in FIG. 7. For example, as described with graphing engine 124 in FIG. 1, the graphing engine may ingest, process, index, and serve data in a verifiable way to the consumer user. Graphing engine 124 may monitor outputs of designated smart contracts for events and index the information. Using the indexed information, subgraphs may define a format by which the indexed information may be provided via APIs to consumer users. The subgraphs may be generated and provided via APIs to consumer users using graphing engine 124.

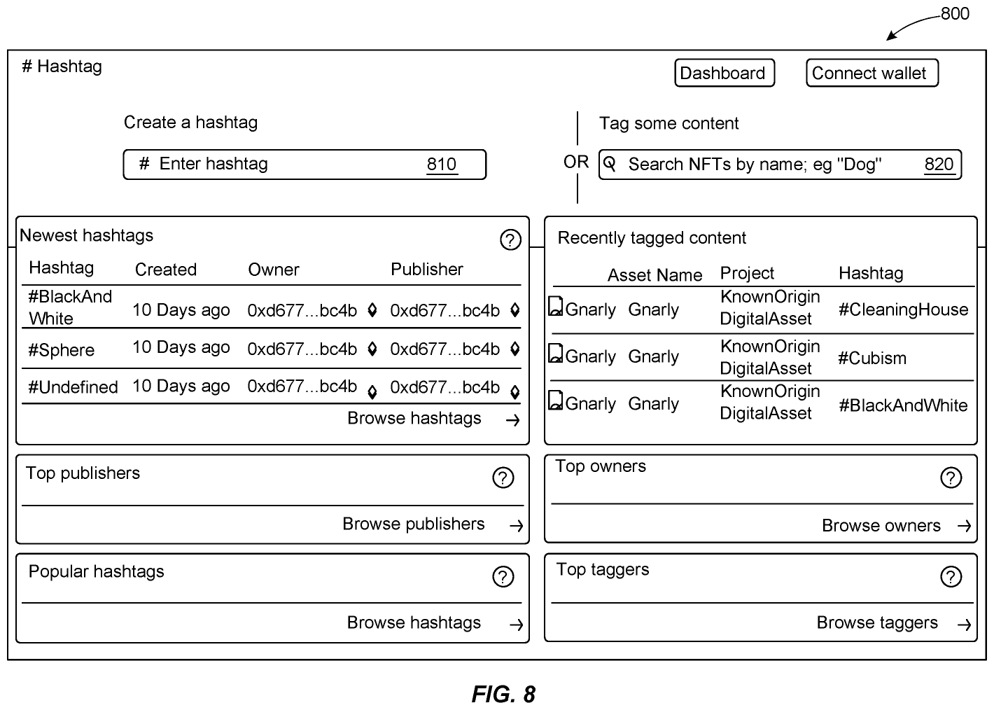

FIG. 8 illustrates a sample interface to create, manage and use tag data, in accordance with the embodiments disclosed herein. In illustration 800, the interface may comprise one or more portions to interact with a Tag Token or digital asset. For example, a user may create a Tag Token by entering a text string in first portion 810 (if the unique tag does not already exist) or tag content with an existing Tag Token in a second portion 820. The interface may be provided by publisher platform 140 and accessed by user computing device 150 via network 160.

Other tag data may be provided as well. For example, a listing of previously created (minted) Tag Tokens may be provided, including the text string associated with the Tag Token, the date that it was created, as well as the owner and/or publisher of the Tag Token. Top publishers, popular tags, recently tag digital assets, top owners, and/or top tagger users may also be provided. This information may be searchable.

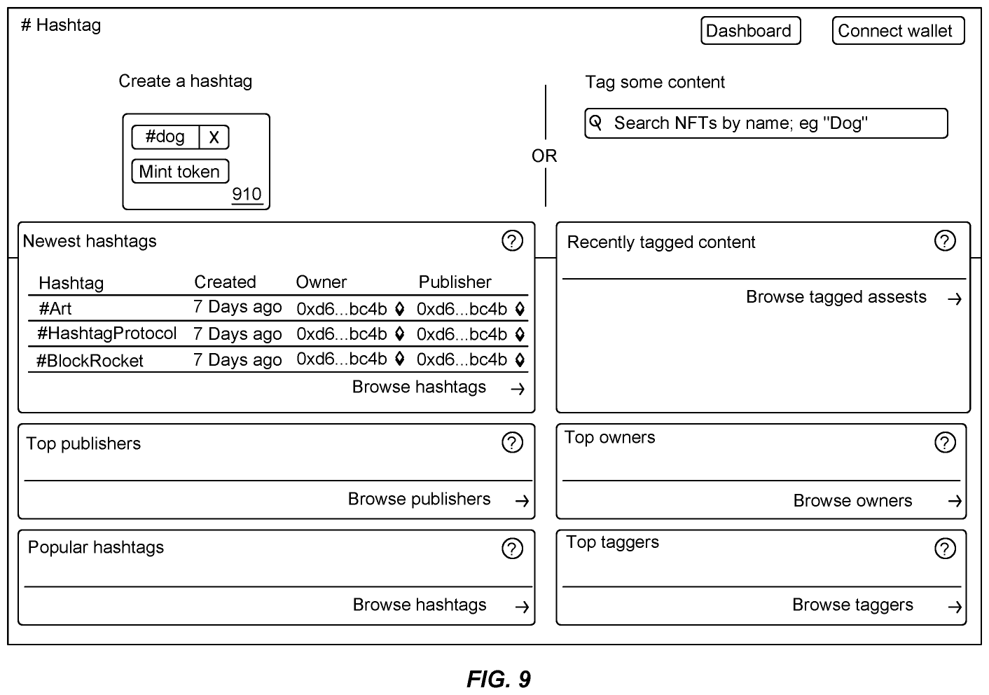

When a user enters a text string in first portion 810, the interface may provide an option to mint the Tag Token via a Mint Token tool 910, as illustrated in FIG. 9. The interface may be updated to display the potential Tag Token before minting (e.g., Tag Token is “dog”).

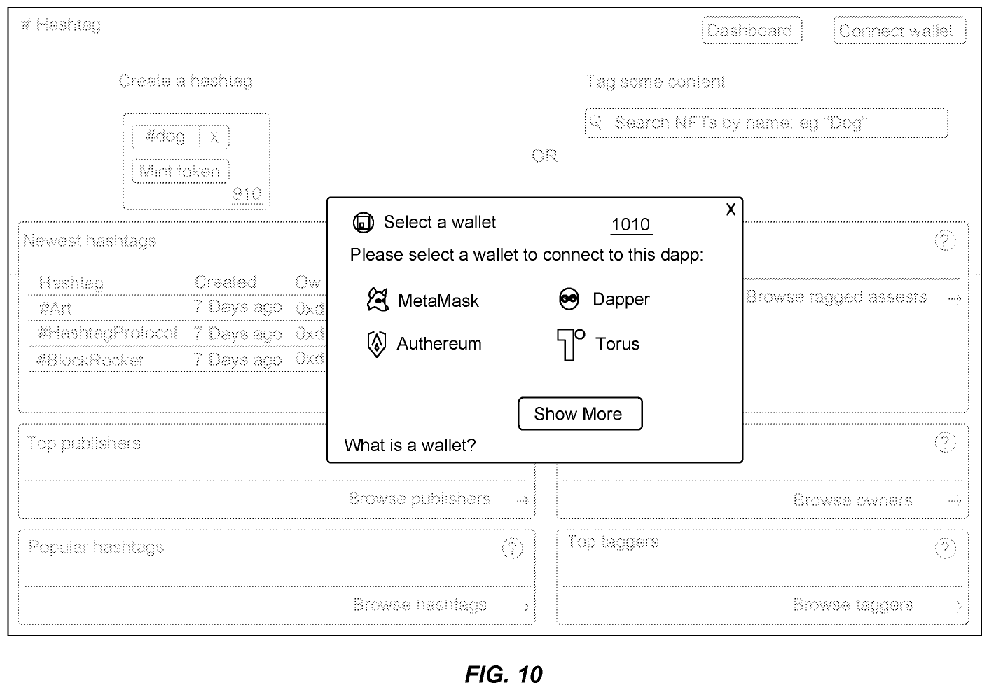

After selecting the Mint Token tool 910, the interface may be updated to provide one or more accounts to associate with the Tag Token as illustrated in FIG. 10. FIG. 10 illustrates an interface to select a user account to associate with the Tag Token. The user account may correspond with a digital wallet or other electronic user profile.

The interface may provide an interface portion 1010 to select a wallet. Wallets may be used to send, receive, and store digital assets, including Tag Tokens. The wallets may come in many forms. For example, a wallet may be built into a browser of a creator user, a browser extension added to the browser of a creator user, a piece of hardware plugged into a computer of a creator user, or even a software application installed on a mobile device of a creator user.

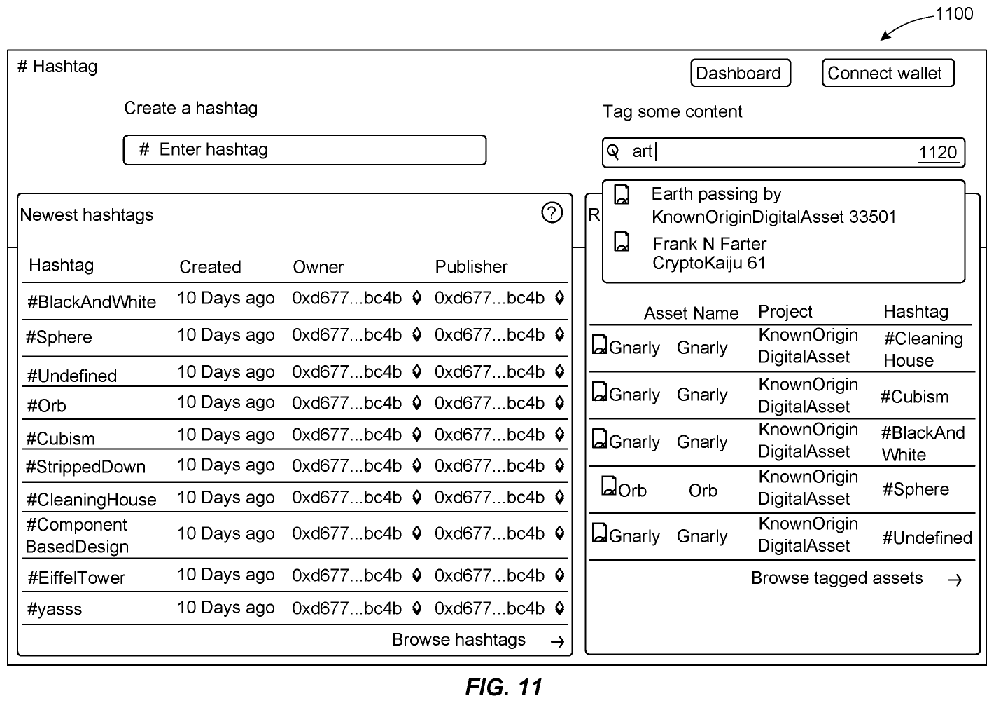

FIG. 11 illustrates an interface to discover a digital asset suitable for tagging. In illustration 1100, the interface may comprise portion 1120 to search for a digital asset target to tag. In some examples, the user may provide a search term to portion 1120 and the interface may present digital assets that match the search term. A user may then select a target of their choice for tagging.

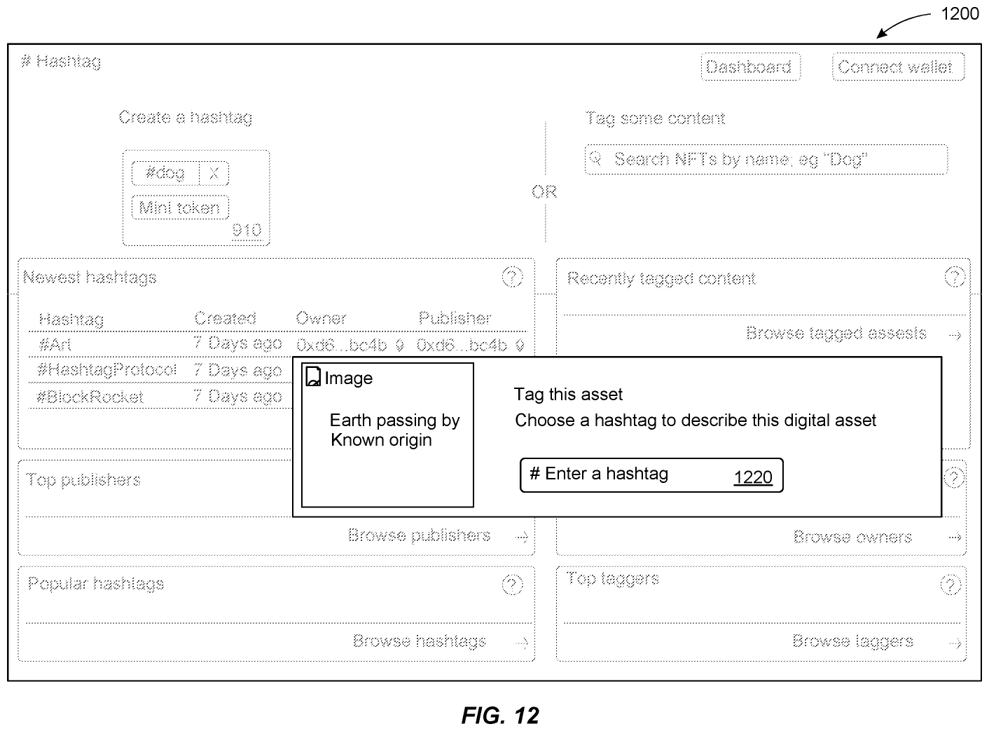

FIG. 12 illustrates an interface to identify a Tag Token for a tagging digital asset. In illustration 1200, the interface may comprise portion 1220, that allows users to search for existing tag tokens to tag the digital asset with. If the desired tag exists, the user may select that tag. If not, the user will have the opportunity to create a new tag token at the point of tagging.

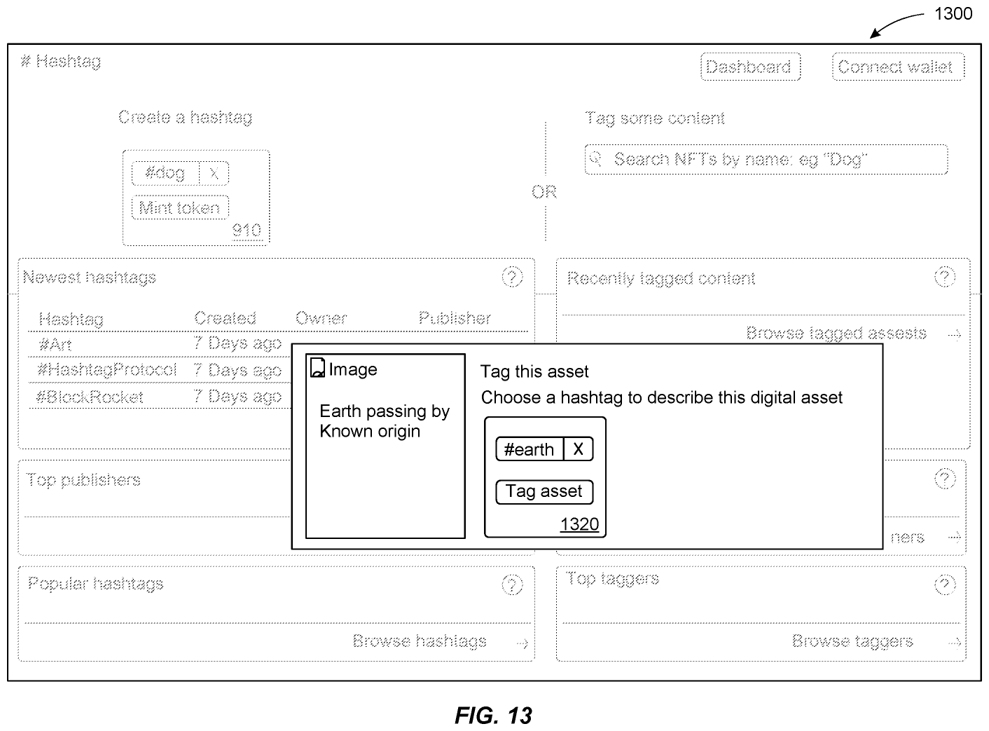

FIG. 13 illustrates an interface to associate a Tag Token with a digital asset. In illustration 1300, the interface may comprise portion 1320, that allows users to create the association of the chosen tag token and the digital asset target.

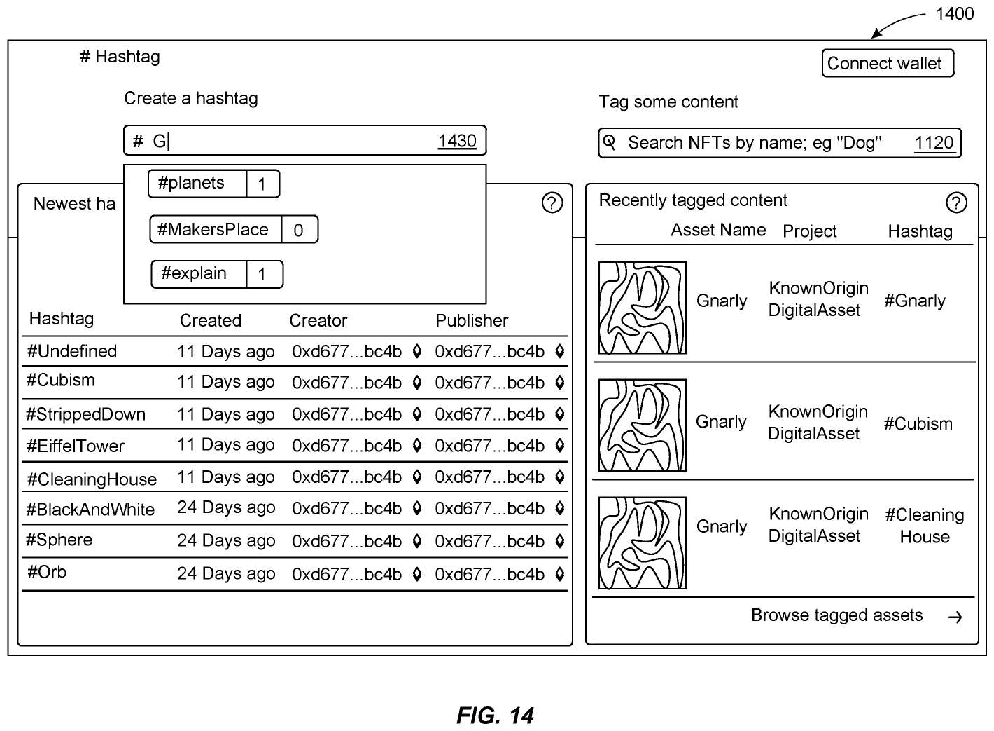

FIG. 14 illustrates an interface to search for existing Tag Tokens. In illustration 1400, the interface may comprise portion 1430, which allows users to search for existing tag tokens by their associated tag string. The interface can show the number of times the tag token has been used to tag digital assets. If no tag exists for the search term, the user may be presented with the opportunity to create a new tag token for that tag string.

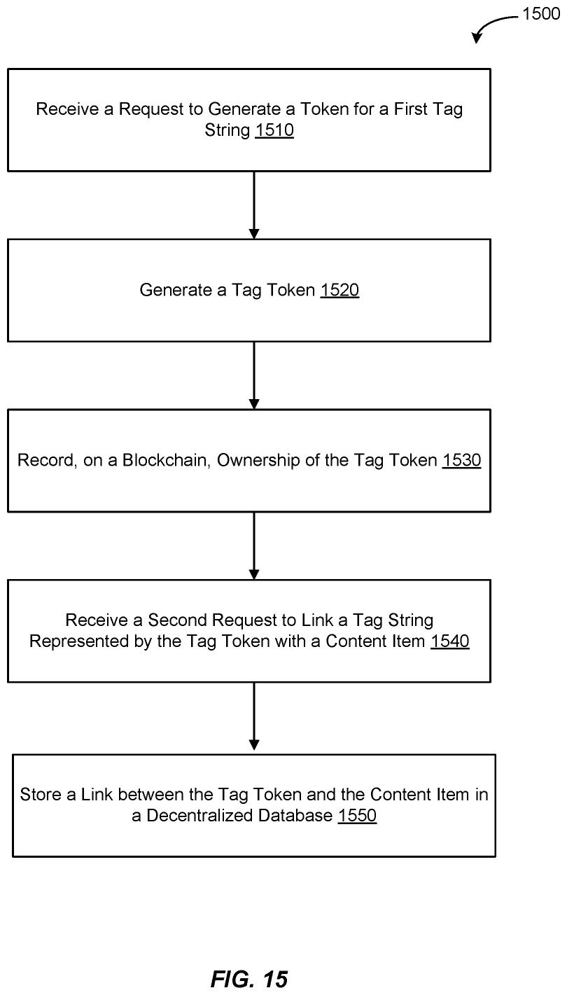

FIG. 15 illustrates a process for implementing the tag protocol decentralized computing system. In this illustration, a tag protocol may implement one or more processes or methods described herein, where the tag protocol corresponds with the computer system described herein. In some examples, the tag protocol may correspond with a decentralized, computer-implemented system for generating, storing, and managing cryptographic non-fungible tokens (NFTs) that represent unique tag strings, linking the tokens to an addressable digital asset, and displaying content tagged with a unique tag string, via an application programming interface (API), on different publisher computer platforms.

At block 1510, the method 1500 may receive a first request to generate a token for a first tag string from a first user. The processor may determine if or whether a tag token exists for the first tag string. The determination may be made by the processor upon electronically receiving a request to generate the token.

At block 1520, the method 1500 may generate a tag token. The tag token may be generated upon determining that no tag token exists for the first tag string. The tag token may comprise a cryptographic non-fungible token (NFT) and represent the first tag string.

At block 1530, the method 1500 may record, on a blockchain, ownership of the tag token. The ownership may correspond with a digital wallet associated with the first user.

At block 1540, the method 1500 may receive a second request to link a tag string represented by a tag token with a content item. In some examples, the content item may correspond with an addressable digital asset or uniform resource locator (URL) of the content item.

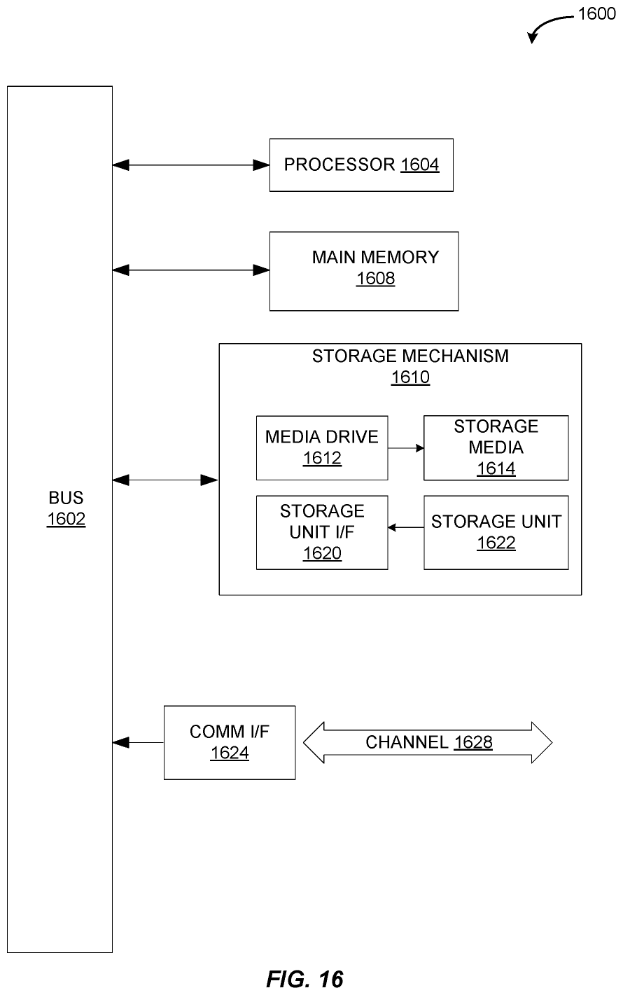

At block 1550, the method 1500 may store a link between the tag token and the content item in a decentralized datastore. The decentralized datastore may be accessible for retrieval by third party platforms, including a plurality of publishing platforms that each attempt to implement platform specific tokens.

Where components, logical circuits, or engines of the technology are implemented in whole or in part using software, in one embodiment, these software elements can be implemented to operate with a computing or logical circuit capable of carrying out the functionality described with respect thereto. One such logical circuit is shown in FIG. 16. Various embodiments are described in terms of this example logical circuit 1600. After reading this description, it will become apparent to a person skilled in the relevant art how to implement the technology using other logical circuits or architectures.

Referring now to FIG. 16, computing system 1600 may represent, for example, computing or processing capabilities found within desktop, laptop, and notebook computers; hand-held computing devices (PDA's, smart phones, cell phones, palmtops, etc.); mainframes, supercomputers, workstations, or servers; or any other type of special-purpose or general-purpose computing devices as may be desirable or appropriate for a given application or environment. Logical circuit 1600 might also represent computing capabilities embedded within or otherwise available to a given device. For example, a logical circuit might be found in other electronic devices such as, for example, digital cameras, navigation systems, cellular telephones, portable computing devices, modems, routers, WAPs, terminals and other electronic devices that might include some form of processing capability.

Computing system 1600 might include, for example, one or more processors, controllers, control engines, or other processing devices, such as a processor 1604. Processor 1604 might be implemented using a general-purpose or special-purpose processing engine such as, for example, a microprocessor, controller, or other control logic. In the illustrated example, processor 1604 is connected to a bus 1602, although any communication medium can be used to facilitate interaction with other components of logical circuit 1600 or to communicate externally.

Computing system 1600 might also include one or more memory engines, simply referred to herein as main memory 1608. For example, preferably random-access memory (RAM) or other dynamic memory, might be used for storing information and instructions to be executed by processor 1604. Main memory 1608 might also be used for storing temporary variables or other intermediate information during execution of instructions to be executed by processor 1604. Logical circuit 1600 might likewise include a read only memory (“ROM”) or other static storage device coupled to bus 1602 for storing static information and instructions for processor 1604.

The computing system 1600 might also include one or more various forms of information storage mechanism 1610, which might include, for example, a media drive 1612 and a storage unit interface 1620. The media drive 1612 might include a drive or other mechanism to support fixed or removable storage media 1614. For example, a hard disk drive, a floppy disk drive, a magnetic tape drive, an optical disk drive, a CD or DVD drive (R or RW), or other removable or fixed media drive might be provided. Accordingly, storage media 1614 might include, for example, a hard disk, a floppy disk, magnetic tape, cartridge, optical disk, a CD or DVD, or other fixed or removable medium that is read by, written to, or accessed by media drive 1612. As these examples illustrate, the storage media 1614 can include a computer usable storage medium having stored therein computer software or data.

In alternative embodiments, information storage mechanism 1640 might include other similar instrumentalities for allowing computer programs or other instructions or data to be loaded into logical circuit 1600. Such instrumentalities might include, for example, a fixed or removable storage unit 1622 and an interface 1620. Examples of such storage units 1622 and interfaces 1620 can include a program cartridge and cartridge interface, a removable memory (for example, a flash memory or other removable memory engine) and memory slot, a PCMCIA slot and card, and other fixed or removable storage units 1622 and interfaces 1620 that allow software and data to be transferred from the storage unit 1622 to logical circuit 1600.

Logical circuit 1600 might also include a communications interface 1624. Communications interface 1624 might be used to allow software and data to be transferred between logical circuit 1600 and external devices. Examples of communications interface 1624 might include a modem or soft modem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1624 might typically be carried on signals, which can be electronic, electromagnetic (which includes optical) or other signals capable of being exchanged by a given communications interface 1624. These signals might be provided to communications interface 1624 via a channel 1628. This channel 1628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 1608, storage unit 1620, media 1614, and channel 1628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the logical circuit 1600 to perform features or functions of the disclosed technology as discussed herein.

Although FIG. 16 depicts a computer network, it is understood that the disclosure is not limited to operation with a computer network, but rather, the disclosure may be practiced in any suitable electronic device. Accordingly, the computer network depicted in FIG. 16 is for illustrative purposes only and thus is not meant to limit the disclosure in any respect.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical, or physical partitioning and configurations can be implemented to implement the desired features of the technology disclosed herein. Also, a multitude of different constituent engine names other than those depicted herein can be applied to the various partitions.

Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “engine” does not imply that the components or functionality described or claimed as part of the engine are all configured in a common package. Indeed, any or all of the various components of an engine, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A decentralized, computer-implemented system for generating, storing, and managing cryptographic non-fungible tokens (NFTs) that represent unique tag strings, linking the tokens to an addressable digital asset, and displaying content tagged with a unique tag string, via an application programming interface (API), on different publisher computer platforms, the system comprising:
a computer processor programmed with computer instructions which when executed cause the processor to:
determine, by the processor, upon electronically receiving a request to generate a token for a first tag string from a first user, if a tag token exists for the first tag string;
upon determining that no tag token exists for the first tag string, generate a tag token comprising a cryptographic NFT and representing the first tag string;
record, on a blockchain, ownership of the tag token by a digital wallet associated with the first user;
receiving a request to link a tag string represented by a tag token with a content item; and
storing a link between the tag token and the content item in a decentralized datastore accessible for retrieval by third party platforms.

2. The decentralized, computer-implemented system of claim 1, further comprising:
a graphing engine that is configured to provide a query language for APIs to access databases to query blockchain data on the blockchain, wherein the blockchain data is stored in token data store.

3. The decentralized, computer-implemented system of claim 1, further comprising:
a smart contract engine that is configured to utilize a shared token data store and shared graphing engine.

4. The decentralized, computer-implemented system of claim 1, wherein the tag token is consistently referenced across the third party platforms in a decentralized manner, and wherein the third party platforms are multiple different platforms.

5. The decentralized, computer-implemented system of claim 1, wherein the processor further to:
when the tag token is generated or the addressable digital asset is linked to the tag token, tagging data is logged to the blockchain.

6. The decentralized, computer-implemented system of claim 1, wherein the first user corresponds with a safelisted publisher address that is authorized to mint the tag token.

7. The decentralized, computer-implemented system of claim 1, further comprising:
a user interface that is configured to provide a search tool for a second user to search for tags and tagged content.

8. The decentralized, computer-implemented system of claim 1, wherein the processor further to:
receive one or more target type subcontracts from one or more user devices at an application programming interface (API) of the decentralized computer system; and
review and approve the one or more target type subcontracts that comply with one or more predetermined rules.

9. The decentralized, computer-implemented system of claim 1, wherein the processor further to:
when the ownership of the tag token by the digital wallet associated with the first user is stored to the blockchain, a smart contract corresponding with the blockchain emits a minting event or tagging event containing transaction data associated with the tag token.

10. The decentralized, computer-implemented system of claim 1, wherein the processor further to:
prior to generating or recording ownership of the tag token, confirm that the tag string stored inside tag token is unique to the universe of existing Tag Tokens and comprises Unicode/UTF-8 characters and no spaces.

11. The decentralized, computer-implemented system of claim 1, wherein the tag token is minted in accordance with ERC-721 specification for tag tokens.

12. A computer-implemented method for generating, storing, and managing cryptographic non-fungible tokens (NFTs) by a decentralized, computer-implemented system, the cryptographic NFTs representing unique tag strings, linking the tokens to an addressable digital asset, and displaying content tagged with a unique tag string, via an application programming interface (API), on different publisher computer platforms, the system comprising:
a computer processor programmed with computer instructions which when executed cause the processor to:
determine, by the processor, upon electronically receiving a request to generate a token for a first tag string from a first user, if a tag token exists for the first tag string;
upon determining that no tag token exists for the first tag string, generate a tag token comprising a cryptographic NFT and representing the first tag string;
record, on a blockchain, ownership of the tag token by a digital wallet associated with the first user;
receiving a request to link a tag string represented by a tag token with a content item; and
storing a link between the tag token and the content item in a decentralized datastore accessible for retrieval by third party platforms.

13. The computer-implemented method of claim 12, further comprising:
providing, by a graphing engine of the decentralized, computer-implemented system, a query language for APIs to access databases to query blockchain data on the blockchain, wherein the blockchain data is stored in token data store.

14. The computer-implemented method of claim 12, further comprising:
utilizing, by a smart contract engine of the decentralized, computer-implemented system, a shared token data store and shared graphing engine.

15. The computer-implemented method of claim 12, wherein the tag token is consistently referenced across the third party platforms in a decentralized manner, and wherein the third party platforms are multiple different platforms.

16. The computer-implemented method of claim 12, further comprising:
when the tag token is generated or the addressable digital asset is linked to the tag token, tagging data is logged to the blockchain.

17. The computer-implemented method of claim 12, wherein the first user corresponds with a safelisted publisher address that is authorized to mint the tag token.

18. The computer-implemented method of claim 12, further comprising:
providing, by a user interface of the decentralized, computer-implemented system, a search tool for a second user to search for tags and tagged content.

19. The computer-implemented method of claim 12, further comprising:
receiving one or more target type subcontracts from one or more user devices at an application programming interface (API) of the decentralized computer system; and
reviewing and approving the one or more target type subcontracts that comply with one or more predetermined rules.

20. The decentralized, computer-implemented system of claim 1, wherein the processor further to:
when the ownership of the tag token by the digital wallet associated with the first user is stored to the blockchain, emitting, by a smart contract corresponding with the blockchain, a minting event or tagging event containing transaction data associated with the tag token.
